(19) United States
(12) Patent Application Publication
(10) Pub. No.: US 2008/0164351 A1
(43) Pub. Date: Jul. 10, 2008

(54) Shutoff mechanism for shredder

(76) Inventor: Tie Chun Wang, Taipei (TW)

Correspondence Address: SEDGWICK, DETERT, MORAN & ARNOLD, LLP (LA), 801 SOUTH FIGUEROA ST., 18TH FLOOR, LOS ANGELES, CA, 90017, US

(21) Appl. No.: 11/650,273

(22) Filed: Jan. 5, 2007

(51) Int. Cl. B02C 23/04; B02C 25/00

(52) U.S. Cl. 241/37.5; 241/301

(57) ABSTRACT

The present invention relates generally to a shutoff mechanism for shredders. The shredder has a shutoff button coupled to the on/off switch whereby activation of the shutoff button results in the on/off switch switching to the off position thereby shutting off power to the shredder.

### BACKGROUND OF THE INVENTION

1. Field of the Invention

The present invention relates generally to shutoff mechanisms for shredders. Specifically, this invention teaches a shutoff mechanism that quickly turns off the power to a shredder.

2. Background Information

With increased privacy concerns, shredders have become an integral part in both homes and businesses. Though originally used to destroy paper products, shredders now are used for other forms of media that hold information, such as compact discs. In addition, credit cards and other plastic products are commonly shredded.

The United States Consumer Product Safety Commission (“CPSC”) published a document entitled Paper Shredder Safety Alert (Document #5127, May 2004). According to this report in the 3 year period from January 2000 through December 2003, the CSPC received 31 reports involving finger amputations, lacerations, and other finger injuries from paper shredders.

In order to reduce the likelihood of injuries, the present invention seeks to employ a shutoff mechanism that can rapidly turn off the power to a shredder.

Prior art shredders are turned on or off by sliding the on/off switch along the surface of the housing of a shredder. Therefore, in order to turn off a shredder a certain amount of dexterity is required in order to slide the switch in the correct direction. In an emergency, it is possible that the user may attempt to slide the switch in the incorrect direction before sliding it into the off position.

The present invention avoids this pitfall by merely requiring the user to push a shutoff button to turn off the shredder. Once the shutoff button is depressed, the on/off switch automatically switches to the off position thus powering down the shredder.

From the preceding descriptions, it is apparent that the devices currently being used have significant disadvantages and/or limitations. Thus, important aspects of the technology used in the field of invention remain amenable to useful refinement.

### SUMMARY OF THE INVENTION

The present invention relates to an apparatus that satisfies the need for a rapid shutoff mechanism for paper shredders. In one preferred embodiment, a shutoff mechanism on a shredder having features of the present invention comprises a shutoff button coupled to an on/off switch. If the shutoff button is depressed while the shredder is on, the shutoff button causes the on/off switch to immediately return to the off position thus shutting down the shredder.

All of the foregoing operational principles and advantages of the present invention will be more fully appreciated upon consideration of the following detailed description with reference to the drawings.

### BRIEF DESCRIPTION OF THE DRAWINGS

The features and advantages of this invention are better understood with regard to the following drawings, description, and claims. The drawings consist of the following:

FIG. 1 is a perspective view of a shredder embodying features of this invention.

FIG. 2 is a top plan view of a shredder housing embodying features of this invention.

FIG. 3(a) is a side view of a shutoff button, springs, and portion of a housing embodying features of this invention.

FIG. 3(b) is a side view of a shutoff button, springs, and portion of a housing embodying features of this invention.

FIG. 3(c) is a side view of a shutoff button, springs, and portion of a housing embodying features of this invention.

FIG. 4(a) is a cross-sectional side view of an apparatus embodying features of this invention.

FIG. 4(b) is a cross-sectional side view of an apparatus embodying features of this invention.

FIG. 5 is a perspective view of a shutoff button, on/off switch and portion of housing embodying features of this invention.

FIG. 6(a) is a bottom plan view of an apparatus embodying features of this invention.

FIG. 6(b) is a bottom plan view of an apparatus embodying features of this invention.

FIG. 7 is a cross-sectional side view of a shutoff button embodying features of this invention.

FIG. 8 is a perspective view of an apparatus embodying features of this invention.

### DETAILED DESCRIPTION OF THE INVENTION

The essential elements of a shredder are comprised of a base 1, a housing 2, and a shredder mechanism (not shown) for shredding materials. This invention discloses a paper or media shredder with a rapid shut-off mechanism. The shredder on/off switch 3 automatically switches off when the shutoff button 4 is depressed.

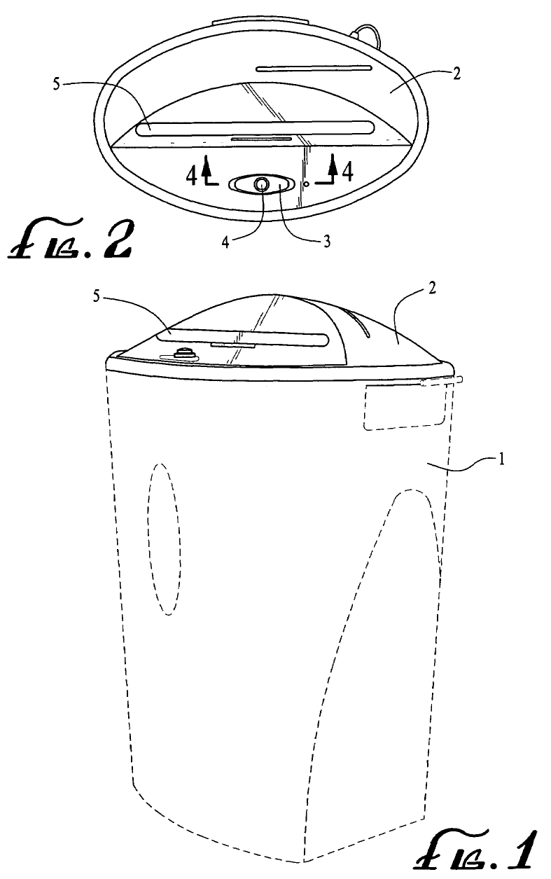

FIGS. 1-8 disclose a preferred embodiment of a shredder with a shut-off mechanism. The housing 2 has a shredder mechanism inside of it and rests on top of the base 1. The base and shredder mechanism can be of any sort commonly known to those skilled in the art and are thus not described herein. The housing has a throat 5 through which material to be shredded is inserted. On the exterior of the housing is an on/off switch 3 coupled to the shredder mechanism, as well as the shutoff button 4.

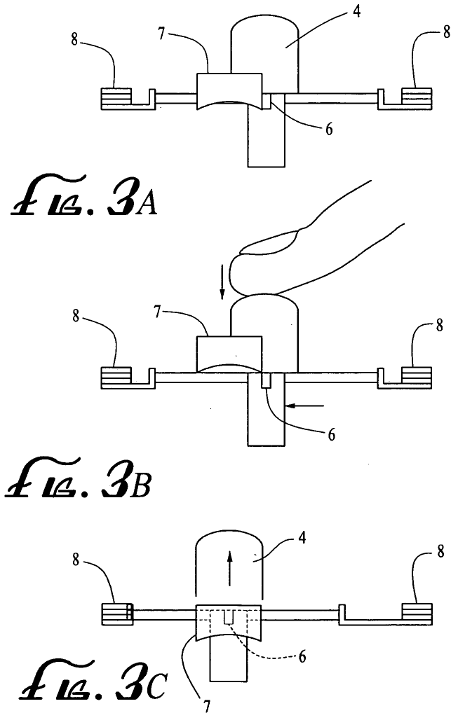

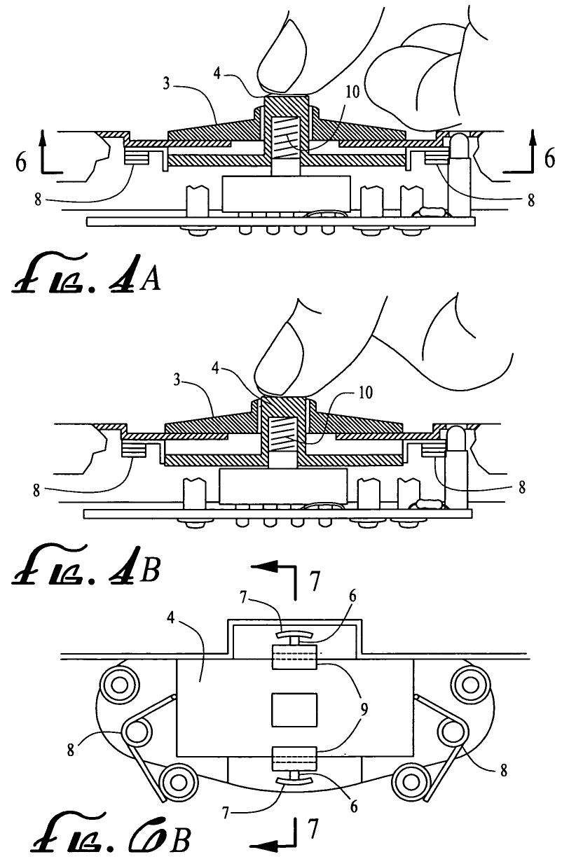

FIG. 3(a) shows the shutoff button 4 while the on/off switch 3 is in the on position. In the on position, the shutoff button 4 and on/off switch 3 are locked in the on position by the shutoff button appendage 6 which abuts a stopper 7 connected to the housing 2. In order to turn off the shredder the shutoff button 4 can be depressed such that the shutoff button appendage 6 moves beneath the housing stopper 7. See FIG. 3(b). The lateral shutoff button springs 8 then move the shutoff button 4 which is coupled to the on/off switch 3 into the off position. See FIG. 3(c).

As seen in FIG. 4(a) the shutoff button 4 is biased towards an upper position by the vertical shutoff button spring 10. The on/off switch 3 has an aperture through which the shutoff button 4 protrudes. In order to turn the shredder on, one simply slides the on/off switch 3 to the on position wherein the shutoff button appendage 6 abuts the housing stopper 7 thus maintaining the on/off switch 3 in the on position.

In order to turn the shredder off, an external force must be placed downward onto the shutoff button 4 thus causing the shutoff button appendage 6 to fall beneath the housing stopper 7. The lateral shutoff button springs 8 then move the shutoff button 4 and the coupled on/off switch 3 into the off position.

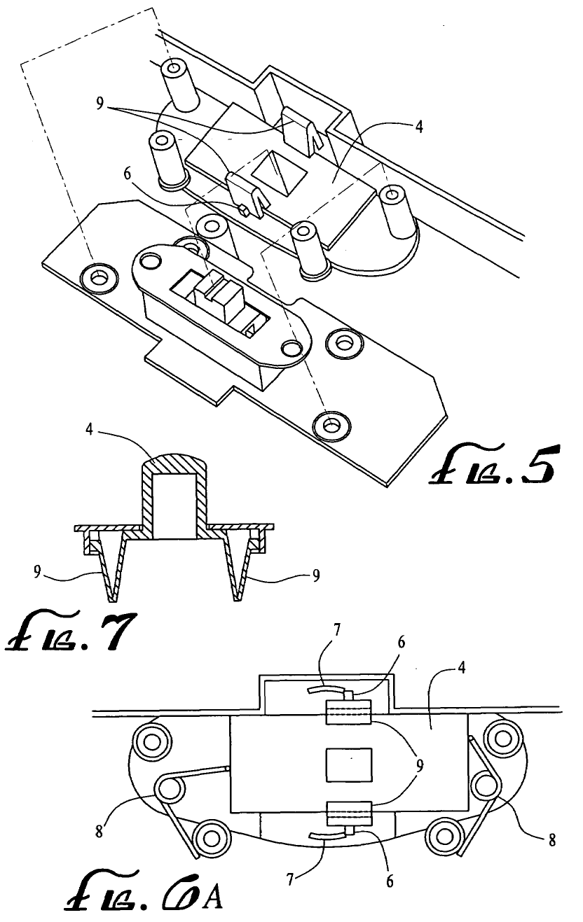

FIG. 5 discloses the bottom of the shutoff button 4 with shutoff button appendages 6 attached to the shutoff button flanges 9. The shutoff button 4 is preferably made of a pliable plastic allowing the flanges 9 to bend.

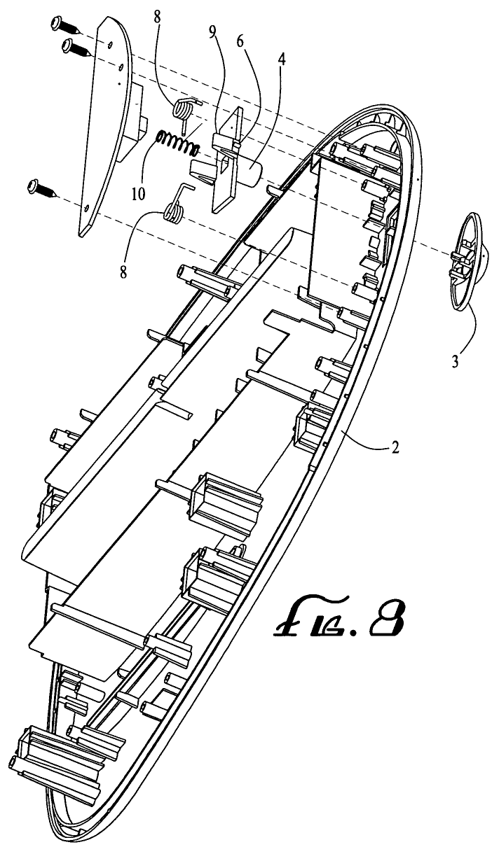

The housing stopper 7 has a curvature which biases the shutoff button and coupled on/off switch into the off position. See FIGS. 6(a) and 6(b). The pliable flange 9 flexes as the appendage 6 follows the curvature of the housing stopper 7. When the on/off switch 3 is slid to the on position, the shutoff button appendage 6 follows the housing stopper 7 until it locks in the on position. See FIG. 6(a). When the shutoff button 4 is depressed, the appendage 6 drops below the housing stopper 7 (See FIGS. 3(a)-3(c)) and the lateral shutoff springs 8 return the shutoff button 4 which is coupled to the on/off switch 3 back to the off position. See FIG. 6(b).

Although the present invention has been described in detail with respect to certain preferred versions thereof, other versions are possible. For example, although the preferred embodiment discloses the shutoff button protruding through the on/off switch, other embodiments may include the shutoff button having locations elsewhere on the shredder housing. In addition, multiple shutoff buttons may be placed on the housing. Therefore, the scope of the claims should not be limited to the description of the preferred versions contained herein.

1. A shredder housing comprised of:
(a) a throat through which materials to be shredded may be fed;
(b) a shredder mechanism for shredding materials fed through the throat;
(c) an on/off switch for turning the shredder mechanism on or off; and
(d) a shutoff button coupled to the on/off switch capable of turning off the shredder when the shutoff button is depressed.

2. The shredder housing of claim 1 wherein said shutoff button is capable of maintaining the on/off switch in the on position.

3. The shredder housing of claim 1 wherein said shutoff button is comprised of an appendage which abuts a housing stopper when the on/off switch is in the on position thereby maintaining the on/off switch in the on position.

4. A shredder housing comprised of:
(a) a throat through which materials to be shredded may be fed;
(b) a shredder mechanism for shredding materials fed through the throat;
(c) an on/off switch for turning the shredder mechanism on or off; and
(d) a shutoff button coupled to the on/off switch capable of turning off the shredder when the shutoff button is depressed,
wherein said shutoff button is comprised of an appendage which abuts a housing stopper when the on/off switch is in the on position thereby maintaining the on/off switch in the on position.
wherein said housing stopper has a curvature which biases the shutoff button and on/off switch into the off position.
